(19) United States
(12) Patent Application Publication
(10) Pub. No.: US 2018/0201056 A1
(43) Pub. Date: Jul. 19, 2018

(54) METHOD FOR WORKING WOOD PASTE

(71) Applicant: Mario CURIONE, Roma (IT)

(72) Inventor: Mario CURIONE, Roma (IT)

(21) Appl. No.: 15/741,808

(22) PCT Filed: Jun. 15, 2016
(86) PCT No.: PCT/IB2016/053529

§ 371 Date: Jan. 4, 2018

(30) Foreign Application Priority Data
Jul. 16, 2015 (IT) 102015000035047

(51) Int. Cl. B44F 9/04; B44C 5/04; C04B 28/02; C04B 18/26; C04B 16/02; C04B 14/34; C04B 28/14

(52) U.S. Cl. CPC B44F 9/04; B44C 5/0453; B44C 5/043; C04B 28/02; C04B 2111/00181; C04B 16/02; C04B 14/34; C04B 28/14; C04B 18/26

(57) ABSTRACT

Method for working wood paste, including: a mixture composed of the conventional mix of flour, white cement, wood sawdust, vinyl glue and hot water, possibly treated in order to obtain an effect similar to the most common stone materials; additives of the mixture constituted by powder pigments or liquid pigments, by dried wood paste chips and possibly by stucco for wood of various colors; a mold constituted by a rigid support adapted to house a layer of wood paste until drying has occurred; the method including: A) mixing the ingredients of a monochromatic mixture are mixed, with the additives in correct order and proportions; B) laying out of the mixture on the suitable molds until completely dry; C) working, including cutting and/or sculpting and inlay, to obtain the desired surface finish; D) polishing, by spreading transparent gloss varnish over the surface or conventional techniques are employed for polishing the wood.

### FIELD OF THE INVENTION

The present invention relates to an innovative technique for preparing and working wood paste to make it look similar to stone, as finished product, in particular similar to precious Roman marble. This invention finds an excellent application in interior ornament designed to recreate mainly, but not exclusively, the environments of ancient Rome in floors, walls, inlaid tables, frames, busts, etc. Another area of application of the wood paste, worked as described in the present invention, is that of jewelry, creating jewels, ornaments, chandeliers, or in footwear creating clogs, wedges etc. Finally, this new compound is particularly adapted to be worked by creative talents and artists or in the field of stage design.

### PRIOR ART

Wood paste is a moldable compound, made exclusively with fine flour, white cement, wood sawdust, vinyl glue and water. It is a ready-to-use monocomponent product which dries quickly by itself without needing heat sources or catalysts. After drying, the wood paste takes a hardness and texture similar to the wood itself and can be sanded, carved, polished, painted or decorated with any type of paint, enamel or color.

It is available on the market ready to use or can be easily made at home. Wood paste is a product currently used in the field of restoration for stuccoing small and large ruptures in wood. It is also used for stuccoing wooden floors, prior to vitrification and for the duplication of missing parts of furniture or frames.

It is also found on the market colored in the classic shades of walnut, mahogany, etc. It is also used in the field of model railways.

The traditional method produces a monochromatic compound on the wood color hues and involves the mixing of:
300 g 00 flour
100 g white cement
100 g fine sawdust
3 tbsp vinyl glue
200 cc warm water (30-35° C.)
   to obtain an elastic paste that can be stored in the refrigerator up to a month. The resulting color is determined by that of sawdust.

The object of the present invention is to propose a technique for making wood paste that makes it suitable for ornamental purposes, being similar to marble.

### DESCRIPTION OF THE INVENTION

According to the present invention, a particular wood paste is made the working of which with a specific method makes it similar to stone elements, even those of greatest value, in order to be used for ornamental or artistic purposes or for the restoration of stone artifacts or the decoration of elements.

Advantageously, said method of working wood paste has the feature of being particularly cost-effective and environment-friendly, as it not only per se consists of waste material, but uses scraps from previous working of the wood paste in the mixture, thereby preventing waste of further waste material.

Advantageously, said method for working wood paste has the feature of returning a considerably lighter material than stone and of other imitations, such as scagliola.

Advantageously, said method of working wood paste starts from a mixture 1 consisting of flour, white cement, sawdust, vinyl glue and hot water, as the traditional mixtures, to which the pigments most suitable for the type of finishing to be obtained are added in the mixing step A.

Advantageously, both powdery pigments to be mixed with flour and cement, and liquid pigments to be mixed with the sawdust, may be added in the mixing step A.

Advantageously, in order to obtain a polychromatic mixture 1, multiple monochromatic mixtures and stucco for white or variously colored wood may be mixed in the proper proportions.

In order to obtain a final effect similar to the most valuable white marbles, said mixture 1 can advantageously contain sawdust, previously bleached with ammonia and hydrogen peroxide at 130 volumes or directly with fir sawdust. Advantageously, in order to obtain the sparkling finish, said mixture 1 can also be admixed with silver powder.

Advantageously, said mixture 1 has a consistency such that a layer, of thickness preferably between 0.3 and 0.5 cm, can be arranged in the spreading step B on dedicated molds 2 which reproduce the desired shape. One of the advantages provided by the use of these molds 2 consists in that they can be of any material selected according to need from: plywood, plaster, plastic.

Advantageously, the plastic mold 2 does not need any treatment of the surface in contact with mixture 1 while for other types of molds 2, it will be necessary to first treat the surface with vaseline paste or with river sand to allow the detachment of mixture 1 after drying.

Advantageously, one can choose to adhere said mixture 1 to said mold 2 after drying, and in this case it will be necessary to apply vinyl glue on the surface of mold 2 in contact with mixture 1 prior to the spreading step B.

Another advantage of the method of working wood paste consists in that said molds 2 may be either planar or three-dimensional for working both surfaces and columns, statues or other types of ornamental objects.

Advantageously said molds 2 can be provided with a reinforcement 3, consisting of a wooden frame of preferred thickness of 1.5 cm, adapted to prevent the deformation or the breakage of mold 2 itself during drying of mixture 1.

Advantageously, once mixture 1 has dried, this can be treated during the working step C like any other stone material, through cutting C.1 or sculpting C.2. Said mixture 1 can also be advantageously worked with common marble working techniques, to form grooves 1.a. to be subsequently filled with another type of wood paste to create the desired ornamental effect. A further advantage of the proposed working method consists in the possibility to make the cutting following a precise design on a dedicated sheet 4, possibly transparent, provided with a plurality of holes 4.a in which corresponding nails 5 are inserted. Once sheet 4 has been removed, a remaining plurality of nails 5 indicates the cutting line to be followed to the worker.

Advantageously, the last step of the method proposed in the present invention is polishing D which allows obtaining a final result totally similar to the most valuable types of marble.

Advantageously, by adding waterproofing, antifungal and/or fire retardants additives to said mixture 1, which are commonly available on the market, the final product may also be used for outdoor surfaces exposed to weathering.

The possibility exists that small cracks are created on the surface of mixture 1 while drying; these can advantageously be filled with stucco for white or colored wood or with dust from glass-papering to impart a “grain” effect particularly aesthetic and typical of marble.

Advantageously, said mixture 1, once dried, through the existing working techniques, can be reduced into filaments usable by 3D printers for the reproduction of stone-like objects.

### DESCRIPTION OF THE FIGURES

The invention will hereinafter be described in at least one preferred embodiment thereof by way of non-limiting example with the aid of the accompanying figures, in which:

FIG. 1 shows an axonometric view of the components necessary for the working of wood paste in one of its possible embodiments: mixture 1 is seen on a mold 2 glued to a reinforcement 3; in the upper part of the figure, the transparent sheet 4 is shown, consisting of a grid with the cutting lines for tiles in regular geometric shapes typical of the opus sectile to be followed with the aid of holes 4.a for nails 5.

FIG. 2 shows the possibility of making tiles 2.1 in the shape of irregular polygons by simply applying sheet 7 onto mixture 1 applied on mold 2 to be used for marble chip floor compositions.

FIG. 3 shows a possible surface treatment in which mixture 1, now dried, is milled to form grooves 1.a that will subsequently be filled with a mixture 1 of a different color.

### DETAILED DESCRIPTION OF THE INVENTION

The wood paste of the present invention consists of the traditional mixture (flour, white cement, wood sawdust, vinyl glue and hot water) admixed with process scraps of other wood pastes consisting of dried fragments to be used for making stone-like materials such as breccia, and powdery pigments or liquid pigments or stucco for white or colored wood.

In particular, the dried fragments, of varying shape and size, are mainly used in the reproduction of “breccia” while, in order to imitate “granites”, the use of a coarser wood sawdust in the mixture is recommended.

Powdery pigments are to be added to mixture 1 before adding the flour, while liquid pigments are added to the wood sawdust that makes up mixture 1 before it is combined with white cement and flour.

In order to obtain a white marble effect, the preferred wood sawdust is fir, as already white, alternatively, the sawdust available can be discolored by treating it with ammonia and hydrogen peroxide at 130 volumes.

Another additive to be added in order to obtain the sparkling effect, which makes the mixture similar to the finest white marble, is silver powder.

For the same purpose it is also possible to use gray cement instead of the traditional white cement.

In order to obtain a polychromatic mixture 1, multiple monochromatic mixtures 1 together with stucco for wood are added in the mixing step A.

Once the desired mixture 1 has been obtained by the mixing step A, a layer of thickness of between 0.3 and 0.5 cm, of compound still in elastic form is spread on a mold 2, on which it lies up to drying (spreading step B). At this point the resulting material can be detached from mold 2 (depending on the pretreatment of the adhesion surface of mold 2) and the working step C starts, which may comprise one or both the cutting C.1 and sculpting C.2 steps, in which mixture 1 now dried is worked with the appropriate techniques to obtain the desired surface finish. A final polishing step D follows, in which transparent gloss paint is spread on the outer surface.

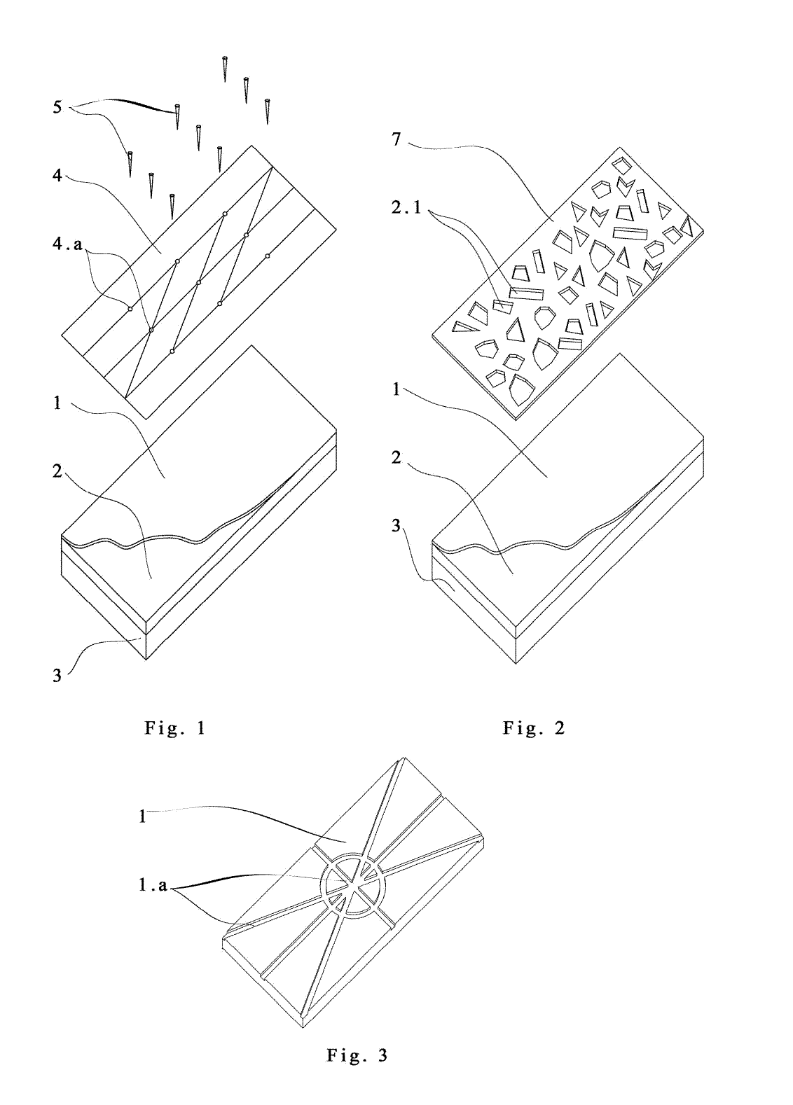

With reference to FIG. 1, a diagram of the spreading step B of mixture 1 is shown. This last spreading step is represented still in elastic form and partially applied to mold 2 which, in this particular embodiment, is rectangular in shape and consists of a plywood surface 2. In order to prevent deformations of mold 2 during the drying of mixture 1, a reinforcement 3 has been glued below plywood 2 consisting of a frame, of wood as well, of minimum thickness of 1.5 cm. Sheet 4 will be applied onto the mixture, preferably transparent, on which the lines to follow for the next cutting are represented. Said sheet 4 is provided with a plurality of holes 4.a in which the worker can insert nails 5, one for each hole 4.a, which remain to indicate the points at which mixture 1 should be cut, when sheet 4 is removed.

Once mixture 1 has dried, it will be possible to work it with exactly the same marble working techniques, it can be for example milled, forming grooves 1.a, in which a further mixture 1 of a different color may be poured to achieve the desired decoration.

In order to imitate the various Roman construction techniques such as opus sectile, or to reproduce the marble chip floor effect, or still, the mosaic, mold 2 and accordingly mixture 1 applied thereon may be cut into tiles 2.1 of various shapes and size. This cut C.1 may be carried out by using sheets (4 in FIG. 1 or 7 in FIG. 2) that reproduce the geometric shapes to imitate the desired technique (opus sectile, marble chip floor, etc.).

Sheet 4 shown in FIG. 1, in particular, serves to make the cut C.1 of mold 2 into various tiles 2.1 of regular geometric shape (rectangular, square, triangular, polygonal), while sheet 7, shown in FIG. 2, in particular serves to make the cut C.1 of mold 2 into various tiles 2.1 of irregular geometric shape (scalene polygons or curved shapes), more suited to reproduce the marble chip floor, or curvilinear shape. The same cutting operation C.1 must be repeated on multiple mixtures 1 in a different color. Subsequently, the resulting tiles 2.1 will be assembled following the design on sheet 4 or 7.

A further possibility to reproduce wall or floor decorations consists in working the upper surface of the dried mixture 1 with a milling cutter to create grooves 1.a in which, in a subsequent step, a wood paste of a different color is spread to form a predetermined design, as shown in FIG. 3.

After drying of paste, it will be removed from mold 2 on which it has dried. In order to facilitate this operation, it is useful to treat the surface on which mixture 1 has to be spread beforehand with vaseline paste or with river sand.

The consistency of the product thus obtained is such as to allow working thereof with all the techniques known to date for working both stone materials and real wood.

Another possibility to use the wood paste of the present invention is provided by the capacity of said paste to adhere also to three-dimensional surfaces to create columns or busts and it can also be used to create entire statues.

Another possible use of the wood paste obtained by the method described can be the reduction into filament used by the existing 3D printers for the reproduction of stone-like Objects.

For use on outdoor surfaces, therefore exposed to weathering, it is sufficient to add to mixture 1, during the mixing step A, the appropriate amount of waterproofing, flame retardant and/or antifungal additives commonly available on the market.

There is also the possibility drying mixture 1 in a mold 2 which gives the shape of a geometric solid to the compound. The result will be for example a small parallelepiped with a stone consistency, which can easily be sculpted just as if it were a stone, but with the advantage of being lighter.

Finally, it is clear that modifications, additions or variants may be made to the invention described thus far which are obvious to a man skilled in the art, without departing from the scope of protection that is provided by the appended claims.

1. Method for working wood paste, comprising:
a mixture (1) composed of the conventional mix, obtained by means of the suitable proportions of flour, white cement, wood sawdust, vinyl glue and hot water, possibly treated in order to obtain an effect similar to the most common stone materials;
a plurality of additives of the mixture (1) constituted by powder pigments or liquid pigments of any color, by dried wood paste chips and possibly by stucco for wood of various colors;
a mold (2) constituted by a rigid support adapted to house a layer of wood paste until drying has occurred;
said method being carried out in the following consecutive steps:
A) mixing step: in which the ingredients of a monochromatic mixture (1) are mixed, and possibly multiple monochromatic mixtures (1) of different color are mixed, with the additives in correct order and proportions;
B) spreading step: laying out of the mixture (1) on the suitable molds (2) until complete drying of said mixture (1) has taken place;
C) working step: which can be articulated in only one or both sub-steps:
C.1) cutting;
C.2) sculpting and inlay;
in which the mixture (1), by now dried, is worked with the suitable techniques in order to obtain the desired surface finish;
D) polishing step: in which one spreads transparent gloss varnish over the external surface or conventional techniques are employed for polishing the wood.

2. Method for working wood paste, according to claim 1, wherein the sawdust of said mixture (1) can be previously decolored in order to obtain the final effect similar to white marble.

3. Method for working wood paste, according to claim 1, wherein among the additives of the mixture (1), a suitable amount of silver powder can be added in order to obtain the sparkling effect typical of some types of stone material.

4. Method and technique for working wood paste, according to claim 1, wherein in order to obtain a polychromatic mixture (1), multiple monochromatic mixtures are joined in the mixing step (A) together with the suitable amount of stucco for wood and chips.

5. Method for working wood paste, according to claim 1, wherein the powder pigments are to be added to the flour and to the cement, while the liquid pigments are to be added to the wood sawdust before composing the mixture (1).

6. Method for working wood paste, according to claim 1, wherein the molds (2) can also be of three-dimensional type in order to allow the reproduction of columns or statues, or they can be box-like containers adapted to allow the sculpting of the obtained wood paste volume.

7. Method for working wood paste, according to claim 1, wherein the molds (2) are provided with a reinforcement (3) adapted to prevent the deformation of said mold (2) during the drying of the mixture (1).

8. Method for working wood paste, according to claim 1, wherein after the drying, a sheet (4) is applied to the external surface the mixture (1), such sheet (4) provided with a plurality of holes (4.a) at the lines of the ornamental design to be followed; in each of said holes (4.a), a corresponding nail (5) is inserted and the sheet (4) is removed in order to allow the nails (5) to delineate the cutting lines which the operator must follow in order to obtain the desired drawing on the surface of the mixture (1).

9. Method for working wood paste, according to claim 1, wherein said molds (2) can be cut into a plurality of pieces (2.1) by using the sheet (7) or the sheet (4) adapted to reproduce the desired geometrical forms.

10. Method for working wood paste, according to claim 1, wherein said mixture (1) can be reduced into filaments for 3D prints adapted for reproducing stone-like objects.

11. Method for working wood paste, according to claim 1, wherein water-proofing additives can be added to the mixture (1), in the mixing step (A), such additives commonly found on the market and adapted to allow the use of the obtained product outdoors.

12. Method for working wood paste, according to claim 1, wherein the product obtained with said method is a polymer adapted to imitate the characteristics of the stone materials commonly available on the market.

13. The method for working wood paste of claim 2, wherein the decoloring step utilizes 130 volume hydrogen peroxide and ammonia.

14. Method for working wood paste, according to claim 2, wherein among the additives of the mixture (1), a suitable amount of silver powder can be added in order to obtain the sparkling effect typical of some types of stone material.

15. Method and technique for working wood paste, according to claim 2, wherein in order to obtain a polychromatic mixture (1), multiple monochromatic mixtures are joined in the mixing step (A) together with the suitable amount of stucco for wood and chips.

16. Method and technique for working wood paste, according to claim 3, wherein in order to obtain a polychromatic mixture (1), multiple monochromatic mixtures are joined in the mixing step (A) together with the suitable amount of stucco for wood and chips.

17. Method for working wood paste, according to claim 2, wherein the powder pigments are to be added to the flour and to the cement, while the liquid pigments are to be added to the wood sawdust before composing the mixture (1).

18. Method for working wood paste, according to claim 3, wherein the powder pigments are to be added to the flour and to the cement, while the liquid pigments are to be added to the wood sawdust before composing the mixture (1).

19. Method for working wood paste, according to claim 4, wherein the powder pigments are to be added to the flour and to the cement, while the liquid pigments are to be added to the wood sawdust before composing the mixture (1).

20. Method for working wood paste, according to claim 2, wherein the molds (2) can also be of three-dimensional type in order to allow the reproduction of columns or statues, or they can be box-like containers adapted to allow the sculpting of the obtained wood paste volume.
